(19) United States
(12) Patent Application Publication
(10) Pub. No.: US 2023/0337273 A1
(43) Pub. Date: Oct. 19, 2023

(54) METHODS AND APPARATUSES FOR RANDOM ACCESS

(71) Applicant: Lenovo (Beijing) Limited, Beijing (CN)

(72) Inventors: Yuantao Zhang, Beijing (CN); Hongmei Liu, Beijing (CN); Zhi Yan, Beijing (CN); Yingying Li, Beijing (CN); Ran Yue, Beijing (CN); Haiming Wang, Beijing (CN)

(73) Assignee: Lenovo (Beijing) Limited, Beijing (CN)

(21) Appl. No.: 18/044,635

(22) PCT Filed: Sep. 11, 2020
(86) PCT No.: PCT/CN2020/114827

§ 371 Date: Mar. 9, 2023

(51) Int. Cl. H04W 72/0457; H04W 74/00

(52) U.S. Cl. CPC H04W 74/002; H04W 72/0457; H04W 74/0833

(57) ABSTRACT

Disclosed are methods for a RA. One embodiment of the subject application provides a method performed by a user equipment, comprising: transmitting a first type of message in a first uplink bandwidth part (BWP) if at least one second uplink BWP is not configured or configured but deactivated, or transmitting the first type of message in the at least one second uplink BWP if the at least one second uplink BWP is configured and activated; and receiving a first type of response message, wherein the first uplink BWP is configured in system information block 1 (SIB1). Related apparatuses are also disclosed.

### TECHNICAL FIELD

Various exemplary embodiments relate to methods and apparatuses for random accesses.

### BACKGROUND OF THE INVENTION

In 3GPP (3^{rd} Generation Partnership Project), in addition to legacy user equipments (UEs), various new types of UEs have emerged, such as industrial wireless sensors, video surveillances, wearables, and etc. Different to the legacy UEs (e.g., enhanced mobile broadband (eMBB) and ultra-reliable low latency communication (URLLC) UEs), these new types of UEs may have the features including e.g., reduced number of receive/transmit antennas, UE bandwidth reduction, half frequency-division duplex, relaxed UE processing time, relaxed UE processing capability, or etc.. These new types of UEs can be referred to as reduced capability (RedCap) UEs.

### SUMMARY

One embodiment of the subject application provides a method performed by a user equipment (UE), comprising transmitting a first type of message in a first uplink (UL) bandwidth part (BWP) if a second UL BWP is not configured or configured but deactivated, or transmitting the first type of message in the second UL BWP if the second UL BWP is configured and activated; and receiving a first type of response message in a downlink(DL) BWP, wherein the first UL BWP is configured in a system information block 1 (SIB1).

Another embodiment of the subject application provides a method performed by a base station (BS), comprising receiving a first type of message in a first UL BWP if a second UL BWP is not configured or configured but deactivated, or receiving the first type of message in the second UL BWP if the second UL BWP is configured and activated; and transmitting a first type of response message in a DL BWP, wherein the first UL BWP is configured by the BS.

A further embodiment of the subject application provides an apparatus, which indicates a non-transitory computer-readable medium having stored thereon computer-executable instructions, a receiving circuitry, a transmitting circuitry, and a processor coupled to the non-transitory computer-readable medium, the receiving circuitry and the transmitting circuitry, wherein the computer-executable instructions cause the processor to implement a method performed by a UE. The method comprises transmitting a first type of message in a first UL BWP if a second UL BWP is not configured or configured but deactivated, or transmitting the first type of message in the second UL BWP if the second UL BWP is configured and activated; and receiving a first type of response message in a DL BWP, wherein the first UL BWP is configured in a SIB1.

Another further embodiment of the subject application provides an apparatus, which indicates a non-transitory computer-readable medium having stored thereon computer-executable instructions, a receiving circuitry, a transmitting circuitry, and a processor coupled to the non-transitory computer-readable medium, the receiving circuitry and the transmitting circuitry, wherein the computer-executable instructions cause the processor to implement a method performed by a UE. The method comprises receiving a first type of message in a first UL BWP if a second UL BWP is not configured or configured but deactivated, or receiving the first type of message in the second UL BWP if the second UL BWP is configured and activated; and transmitting a first type of response message in a DL BWP, wherein the first UL BWP is configured by the BS.

### BRIEF DESCRIPTION OF THE DRAWINGS

Some example embodiments will now be described, by way of non-limiting examples, with reference to the accompanying drawings.

FIG. 1 illustrates an exemplary method for a random access (RA), in accordance with some embodiments of the present disclosure.

FIG. 2 illustrates an exemplary signal sequence for RA, in accordance with some embodiments of the present disclosure.

FIG. 3 illustrates an exemplary switching indicator contains in a medium access control (MAC) sub protocol data unit (PDU), in accordance with some embodiments of the present disclosure.

FIG. 4 illustrates an exemplary method for RA, in accordance with some embodiments of the present disclosure.

FIG. 5 illustrates an exemplary signal sequence for RA, in accordance with some embodiments of the present disclosure.

FIG. 6 illustrates an exemplary method for RA, in accordance with some embodiments of the present disclosure.

FIG. 7 illustrates an exemplary signal sequence for RA, in accordance with some embodiments of the present disclosure.

FIG. 8 illustrates an exemplary signal sequence for restart a RA procedure, in accordance with some embodiments of the present disclosure.

FIG. 9 illustrates an exemplary signal sequence for restart a RA procedure, in accordance with some embodiments of the present disclosure.

FIG. 10 illustrates an exemplary restarted a RA procedure, in accordance with some embodiments of the present disclosure.

FIG. 11 illustrates an exemplary restarted a RA procedure, in accordance with some embodiments of the present disclosure.

FIG. 12 illustrates an exemplary restarted a RA procedure, in accordance with some embodiments of the present disclosure.

FIG. 13 illustrates an exemplary restarted a RA procedure, in accordance with some embodiments of the present disclosure.

FIG. 14 illustrates an exemplary restarted a RA procedure, in accordance with some embodiments of the present disclosure.

FIG. 15 illustrates an exemplary method for RA, in accordance with some embodiments of the present disclosure.

FIG. 16 illustrates an exemplary apparatus, in accordance with some embodiments of the present disclosure.

FIG. 17 illustrates an exemplary apparatus, in accordance with some embodiments of the present disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G and so on. It is contemplated that along with developments of network architectures and new service scenarios, all embodiments in the present application are also applicable to similar technical problems, and moreover, the terminologies recited in the present application may change, which should not affect the principle of the present application.

The present disclosure generally relates to RA procedures.

In 5G, in addition to the legacy UEs, there may be other various types of UEs, for example, the RedCap UEs. These RedCap UEs may access the network with full backward compatibility. Same as the legacy UEs, the RedCap UEs may detect legacy synchronization signal and physical broadcast channel (PBCH) blocks (i.e., SSBs) to synchronize to downlink, the RedCap UEs may obtain physical cell identifier (ID) and the information in a master information block (MIB), etc., then the RedCap UEs may detect legacy system information block 1 (SIB1) in the initial BWP. Based on the configurations in SIB1, the RedCap UEs then detect paging and/or start RA procedures depending on e.g., DL/UL data availability, and finish the initial access procedure.

That is to say, the RedCap UEs may occupy the same resources that used by the legacy UEs for RA procedures. Therefore, in some scenarios, e.g., when there are a large number of RedCap UEs trying to access the network, the performance of the legacy UEs (e.g., the eMBB and URLLC UEs) might be degraded during the RA procedure. For example, there might be high collision rate for the transmitted physical RA channel (PRACH) preambles, which results in delayed access for the legacy UEs. As another example, in addition to the UE transmitting a first type of message (hereinafter referred as Msg1) and receiving a first type of response message (hereinafter referred as Msg2), the RA procedure may further include the UE transmitting a second type of message (hereinafter referred as Msg3) to the BS and the UE receiving a second type of response message (hereinafter referred as Msg4) from the BS, the scheduling opportunity for transmitting/receiving the Msg3 or the Msg4 for RA of the legacy UEs might be reduced if a base station (BS, e.g., a gNB) cannot identify the RedCap UEs before Msg3/Msg4, which will also lead to the delayed access of the legacy UEs.

For a legacy RA, an initial downlink (DL) BWP and an initial UL BWP are used for messaging.

FIG. 1 illustrates an exemplary method 100 performed by a UE to perform a RA according to the present disclosure.

As shown in FIG. 1, the method 100 may at least include an operation 110 of transmitting a Msg1 to a base station (BS) in a first UL BWP (hereinafter mentioned as UL BWP1) if a second UL BWP (hereinafter mentioned as UL BWP2) is not configured or configured but deactivated, or transmitting the Msg1 in the UL BWP2 if the UL BWP2 is configured and activated, and an operation 120 of receiving a Msg2 from the BS in a DL BWP, wherein the UL BWP1 is configured in the SIB1, the DL BWP is a legacy BWP for a legacy RA.

In some embodiments, the BS may be referred to as an access point, an access terminal, a base, a base unit, a macro cell, a Node-B, an evolved Node B (eNB), a generalized NodeB (gNB), a Home Node-B, a relay node, or a device, or described using other terminology used in the art.

In some embodiments, the UL BWP1 and the DL BWP are the initial BWPs used by the legacy UEs for legacy RAs.

In some embodiments, the UE receives the Msg2 in the initial DL BWP used by the legacy UEs for legacy RAs.

In some embodiments, the Msg2 can be a MAC PDU which includes one or more MAC sub PDUs.

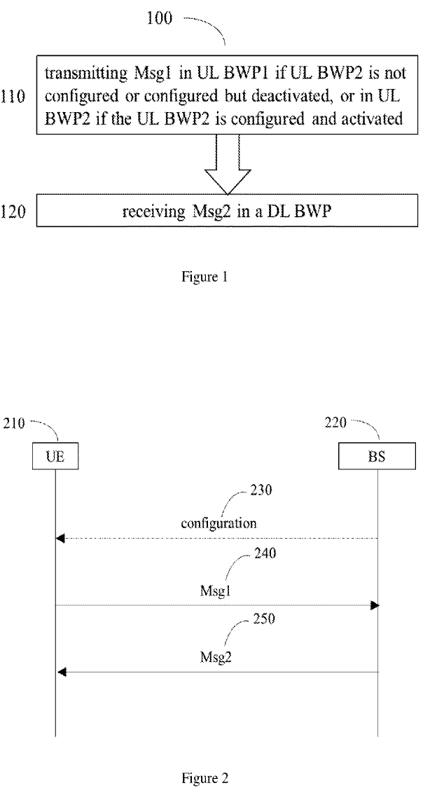

FIG. 2 illustrates an exemplary signal sequence of a RA procedure according to the method 100.

As shown in FIG. 2, the BS 220 may transmit a configuration 230 to the UE 210. In some embodiments, the configuration 230 is included in the SIB1. If the BS 220 does not transmit the configuration 230, or the UL BWP2 is not configured, the UE 210 may follow the legacy RA. Any switching indicator in the Msg2 is ignored.

In some embodiments, the configuration 230 configures a UL BWP2, and activates or deactivates the UL BWP2.

In some embodiments, the configuration 230 may configure other UL BWPs (e.g., the UL BWP3) in addition to the UL BWP1 and the UL BWP2 and activate or deactivate these UL BWPs respectively.

In some embodiments, the UL BWP2 is configured by a signaling in the SIB1, and is activated or deactivated by another signaling in the SIB1.

As shown in FIG. 2, the UE 210 further transmits an Msg1 240 to the BS 220, and receive an Msg2 250 from the BS 220.

In some embodiments, if the UL BWP2 is configured but deactivated, the UE 210 may transmit the Msg1 240 to the BS 220 in the UL BWP1.

In some embodiments, if the UL BWP2 is configured and activated, the UE 210 may transmit the Msg1 240 to the BS 220 in the UL BWP2.

In some embodiments, the Msg2 250 may or may not include a switching indicator for activating or deactivating the configured UL BWP2 and for instructing UE to do BWP switching.

In some embodiments, the Msg2 250 may include at least one switching indicator in the Msg2 for activating or deactivating the UL BWP2, if the UL BWP2 is configured by the configuration 230.

In some embodiments, the Msg2 250 may include one switching indicator in a MAC sub PDU, and/or include one switching indicator in a UL grant for scheduling an Msg3.

In some embodiments, when the UE 210 receives the Msg2, the UE 210 may check whether there is a switching indicator included in the Msg2.

In some embodiments, if the Msg2 250 is not detected or the Msg2 250 does not match the Msgl, and if the UL BWP2 is configured by the configuration 230, the UE 210 may check whether there is a switching indicator in a MAC sub PDU in the Msg2 250. In one embodiment, if a switching indicator exists and instructs UE to do BWP switching, UE may switch to a UL BWP2 to restart the RA procedure.

In the present disclosure, the Msg2 (e.g., Msg2 250) matches the Msg1 (e.g., Msg1 240) means that the received Msg2 contains the preamble ID transmitted in the Msgl, and the Msg2 does not match the Msg1 means that the received Msg2 does not contain the preamble ID transmitted in the Msg1.

In some embodiments, if the UE 210 receives an Msg2 250 and the Msg2 250 matches the Msg1 240, and the UL BWP2 is configured by the configuration 230, the UE 210 may check whether there is a switching indicator in a UL grant in the Msg2 250 for scheduling the Msg3.

In some embodiments, if the Msg2 250 includes a corresponding switching indicator, the UE 210 may determine the UL BWP (UL BWP1 or UL BWP2) for possible subsequent transmission of the RA messages according to the configuration 230 and the corresponding switching indicator.

In some embodiments, the Msg2 250 does not include a corresponding switching indicator, the UE 210 continues to use the previously used UL BWP for possible subsequent transmission.

If the UL BWP2 is configured by the configuration 230 and is deactivated by the switching indicator, the UE 210 may use the UL BWP1 for subsequent transmission of the RA messages, no matter whether the configuration 230 activates or deactivates the UL BWP2.

If the UL BWP2 is configured by the configuration 230 and is activated by the switching indicator, the UE 210 may use the UL BWP2 for subsequent transmission of the RA messages, no matter whether the configuration 230 activates or deactivates the UL BWP2.

In some embodiments, at least one UL BWP is configured by the configuration 230, and is activated or deactivated by the configuration 230 and/or the switching indicator; and the UE 210 may use the at least one UL BWP for transmitting at least one RA message (e.g., the Msg1 240).

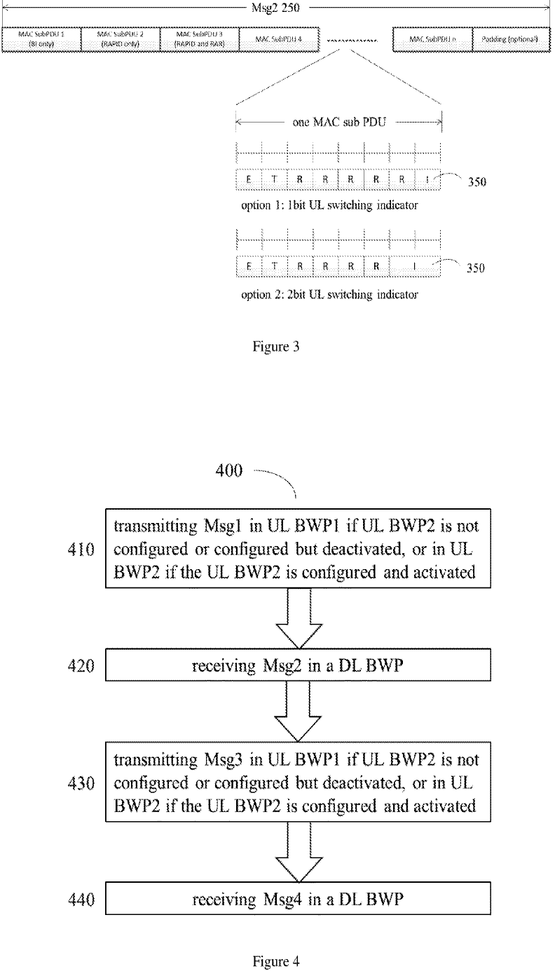

FIG. 3 illustrates an exemplary switching indicator 350 in a MAC sub PDU in the Msg2. The Msg2 250 can be a MAC PDU which may include one or more MAC sub PDUs, among these MAC sub PDUs, there is a MAC sub PDU including the switching indicator 350.

In some embodiments, the BS 220 configures one UL BWP, e.g., the UL BWP2, in addition to the UL BWP1. The switching indicator 350 may be one bit as shown in option 1 in FIG. 3. In some embodiments, if the switching indicator 350 is “0,” it means deactivating the UL BWP2; and if the switching indicator 350 is “1,” it means activating the UL BWP2.

In some embodiments, the BS 220 configures multiple UL BWPs in addition to the UL BWP1. Correspondingly, the switching indicator 350 may be multiple bits. For example, the switching indicator 350 may be two bits as shown in option 2 in FIG. 3, it means that the BS 220 may configure up to 4 UL BWPs in addition to the UL BWP1.

In some embodiments, if the UE 210 receives the Msg2 250 and the Msg2 250 matches the Msg1, the UE 210 may further transmit an Msg3 to the BS 220 and receive an Msg4 from the BS 220.

FIG. 4 illustrates an exemplary method 400 performed by a UE 210 to perform a RA according to the present disclosure, wherein the Msg2 matches the Msg1.

As shown in FIG. 4, the method 400 may at least include an operation 410 of transmitting the Msg1 to the BS 220 in the UL BWP1 if the UL BWP2 is not configured or configured but deactivated, or transmitting the Msg1 to the BS 220 in the UL BWP2 if the UL BWP2 is configured and activated, an operation 420 of receiving the Msg2 in a DL BWP from the BS 220, an operation 430 of transmitting the Msg3 to the BS 220 in the UL BWP1 if the UL BWP2 is not configured or configured but deactivated, or transmitting the Msg3 to the BS 220 in the UL BWP2 if the UL BWP2 is configured and activated, and an operation 440 of receiving the Msg4 in a DL BWP from the BS 220, wherein the UL BWP1 is configured in the SIB1.

In some embodiments, the UL BWP1 is available for all the UEs.

In some embodiments, the UL BWP1 and the DL BWP are the initial BWPs used by the legacy UEs in the legacy RA.

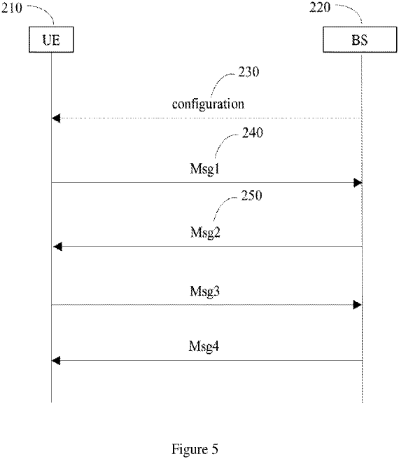

FIG. 5 illustrates an exemplary signal sequence of an RA procedure according to the method 400.

As shown in FIG. 5, the BS 220 may transmit a configuration 230 to the UE 210. In some embodiments, the configuration 230 is included in the SIB1.

If the BS 220 does not transmit the configuration 230, the UE 210 may follow the legacy RA. Any switching indicator in the Msg2 250 is ignored.

In some embodiments, if the UL BWP2 is configured but deactivated, the UE 210 may transmit the Msg1 240 to the BS 220 in the UL BWP1.

In some embodiments, if the UL BWP2 is configured and activated, the UE 210 may transmit the Msg1 240 to the BS 220 in the UL BWP2.

In some embodiments, the Msg2 250 may not include a switching indicator for activating or deactivating the configured UL BWP2.

In some embodiments, the Msg2 250 may include at least one switching indicator for activating or deactivating the UL BWP2 and instructing UE to do BWP switching, if the UL BWP2 is configured by the configuration 230.

In some embodiments, the Msg2 250 may include one switching indicator in a MAC sub PDU, and/or include one switching indicator in a certain UL grant.

In some embodiments, when the UE 210 receives the Msg2 250, the UE 210 may check whether there is a switching indicator included in the Msg2 250.

In some embodiments, if the Msg2 is not detected or the Msg2 250 does not match the Msgl, and if the UL BWP2 is configured by the configuration 230, the UE 210 may check whether there is a switching indicator in a MAC sub PDU in the Msg2 250. In one embodiment, if a switching indicator instructs UE to do BWP switching, UE may switch to a UL BWP2 to restart the RA procedure.

In some embodiments, if the UE 210 receives an Msg2 250 and the Msg2 250 matches the Msg1 240, and the UL BWP2 is configured by the configuration 230, the UE 210 may check whether there is a switching indicator in a UL grant of the Msg2 250 for scheduling the Msg3. The UE 210 ignores any switching indicator contained in any MAC sub PDU in the Msg2 250.

In some embodiments, if the Msg2 250 includes a corresponding switching indicator, and the UL BWP2 is configured, the UE 210 may determine the UL BWP (UL BWP1 or UL BWP2) for possible subsequent transmission according to the corresponding switching indicator.

In some embodiments, the Msg2 250 does not include a corresponding switching indicator, and the UE 210 continues to use the previously used UL BWP (UL BWP1 or UL BWP2) for possible subsequent transmission.

According to the method 400 shown in FIG. 4 and the signal sequence for RA shown in FIG. 5, as the Msg 2 250 matches the Msg1 240, the UE 210 may further transmit an Msg3 to the BS 220 and receive an Msg4 from the BS 220. If the UL grant in the Msg2 250 for scheduling the Msg3 contains the switching indicator, the UE may check if the switching indicator actives or deactivates the UL BWP2.

If the UL BWP2 is deactivated by the switching indicator, the UE 210 transmits Msg3 in the UL BWP1.

If the UL BWP2 is activated by the switching indicator, the UE 210 may switch to UL BWP2 and transmit the Msg3 in the UL BWP2.

If the UL grant in the Msg2 250 for scheduling the Msg3 does not contain any switching indicator, the UE may transmit the Msg3 in the same UL BWP in which the Msg1 240 is transmitted.

The UL BWP used for transmitting the Msg3 may be the same as or different from the UL BWP used for transmitting the Msg1 240.

For example, the Msg1 240 is transmitted in the UL BWP1 due to that the UL BWP2 is configured but deactivated, if the switching indicator in the Msg2 250 activates the UL BWP2, the Msg3 is transmitted in the UL BWP2.

For example, the Msg1 240 is transmitted in the UL BWP2 due to that the UL BWP2 is configured and activated, if the switching indicator in the Msg2 250 deactivates the UL BWP2, the Msg3 is transmitted in the UL BWP1.

For example, the Msg1 240 is transmitted in the UL BWP2 due to that the UL BWP2 is configured and activated, if the Msg2 250 does not contain a switching indicator, the UE continues to use the UL BWP2 for transmission of the Msg3.

For example, the Msg1 240 is transmitted in the UL BWP1 due to that the UL BWP2 is configured and deactivated, if the Msg2 250 does not contain a switching indicator, the UE continues to use the UL BWP1 for transmission of the Msg3.

For a legacy RA, the legacy UEs use an initial DL BWP for receiving messages (e.g., Msg2 and/or Msg4).

In the present disclosure, the BS configures DL BWP1 in SIB1, which is available for all the UEs including the legacy UEs and the RedCap UEs. The DL BWP1 is the initial DL BWP used in the legacy RAs.

The BS may further configure a DL BWP2 and activates or deactivates the DL BWP2 in SIB1. If the DL BWP2 is configured and activated in Msg2, the UE may receive the Msg2 and/or Msg4 in the DL BWP2.

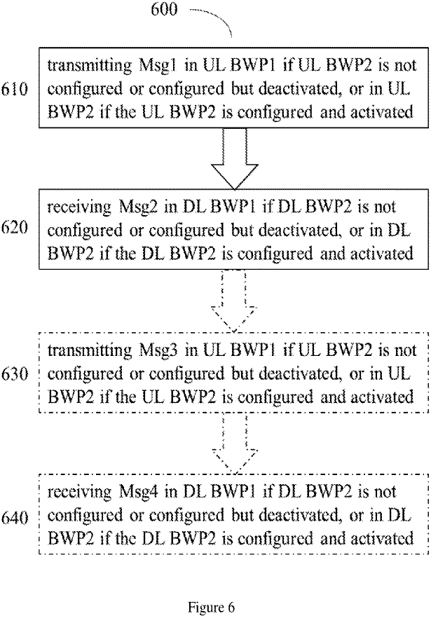

FIG. 6 illustrates an exemplary method 600 performed by a UE to perform a RA according to the present disclosure, wherein the Msg2 matches the Msg1.

As shown in FIG. 6, the method 600 may at least include an operation 610 of transmitting an Msg1 to the BS in the UL BWP1 if the UL BWP2 is not configured or configured but deactivated, or transmitting the Msg1 to the BS in the UL BWP2 if the UL BWP2 is configured and activated, and an operation 620 of receiving an Msg2 in the DL BWP1 if the DL BWP2 is not configured or configured but deactivated, or in the DL BWP2 if the DL BWP2 is configured and activated.

If the Msg2 matches the Msgl, the method 600 may further include an operation 630 of transmitting a Msg3 to the BS in the UL BWP1 if the UL BWP2 is not configured or configured but deactivated, or transmitting the Msg3 to the BS in the UL BWP2 if the UL BWP2 is configured and activated, and an operation 640 of receiving a Msg4 in the DL BWP1 if the DL BWP2 is not configured or configured but deactivated, or in the DL BWP2 if the DL BWP2 is configured and activated, wherein the UL BWP1 and the DL BWP1 is configured in the SIB1.

In some embodiments, the UL BWP1 and the DL BWP1 are the initial BWPs for the legacy RA and are available for all the legacy UEs.

FIG. 7 illustrates an exemplary signal sequence of an RA procedure according to the method 600.

As shown in FIG. 7, the BS 720 may transmit a configuration 730 to the UE 710. In some embodiments, the configuration 730 is included in the SIB1.

If the BS 720 does not transmit the configuration 730, the UE 710 may follow the legacy RA. Any switching indicator in the Msg2 750 is ignored.

If the configuration 730 does not configure the UL BWP2, the UE 710 may transmit the Msg1 740 and/or the Msg3 in a legacy way.

The configuration 730 does not configure the DL BWP2, the UE 710 may receive the Msg2 and/or the Msg4 in a legacy way.

In some embodiments, the configuration 730 configures at least one of the UL BWP2 and the DL BWP2.

In some embodiments, a DL BWP2 is configured. The switching indicator in Msg2 indicates the BWP switching to the DL BWP2. The UE may receive the Msg2 and/or Msg4 in the DL BWP2.

In some embodiments, a DL BWP2 is configured and associated with a UL BWP, e.g., UL BWP2. The switching indicator in Msg2 instructs the BWP switching for both UL and DL.

In some embodiments, multiple DL BWPs are configured. The switching indicator in Msg2 indicates the BWP switching to one of the DL BWP. The UE may receive the Msg2 and/or Msg4 in the DL BWP.

In some embodiments, multiple DL BWPs are configured, and each is associated with a configured UL BWP. The switching indicator in Msg2 instructs the BWP switching for both UL and DL.

Regarding the configuration and the usage of the UL BWP2, please refer to the previous various embodiments and examples.

The configuration and the usage of the DL BWP2 are similar to that of the UL BWP2.

In some embodiments, if the DL BWP2 is configured but deactivated, the UE 710 may receive the Msg2 750 from the BS 720 in the DL BWP1.

In some embodiments, if the DL BWP2 is configured and activated, the UE 710 may receive the Msg2 750 from the BS 720 in the DLBWP2.

In some embodiments, the Msg2 750 does not include a switching indicator.

In some embodiments, the Msg2 750 includes a switching indicator for activating or deactivating the UL BWP2 and/or the DL BWP2.

In some embodiments, the Msg2 750 may include at least one switching indicator.

In some embodiments, the Msg2 750 may include one switching indicator in a MAC sub PDU, and/or include one switching indicator in a UL grant for scheduling an Msg3.

In some embodiments, when the UE 710 receives the Msg2 750, the UE 710 may check whether there is a switching indicator included in the Msg2 750.

In some embodiments, if the Msg2 750 is not detected or the Msg2 750 does not match the Msg1 740, and if at least one of the UL BWP2 and the DL BWP2 are configured by the configuration 730, the UE 710 may check whether there is a switching indicator in a MAC sub PDU in the Msg2 750.

In some embodiments, if the UE 710 receives an Msg2 750 and the Msg2 750 matches the Msg1 740, and at least one of the UL BWP2 and the DL BWP2 is configured by the configuration 730, the UE 710 may check whether there is a switching indicator in a UL grant of the Msg2 750 for scheduling the Msg3. The UE ignores any switching indicator contained in any MAC sub PDU in the Msg2 750.

In some embodiments, if the Msg2 750 contains a corresponding switching indicator, and at least one of the DL BWP2 and the UL BWP2 is configured, the UE 710 may determine at least one of the DL BWP and the UL BWP for possible subsequent transmission according to the corresponding switching indicator.

In some embodiments, the Msg2 750 does not contain a corresponding switching indicator, the UE 710 continues to use the previously used BWPs for possible subsequent transmission.

According to the method 600 shown in FIG. 6 and the signal sequence for RA shown in FIG. 7, if the Msg2 750 matches the Msg1 740, the UE 710 may further transmit an Msg3 to the BS 720 and receive an Msg4 from the BS 720. If the UL grant in the Msg2 750 for scheduling the Msg3 contains the switching indicator, the UE 710 may check if the switching indicator actives or deactivates the UL BWP2 and/or the DL BWP2.

If the configured DL BWP2 is deactivated by the switching indicator, the UE 710 may receive Msg4 in the DL BWP1.

If the configured DL BWP2 is activated by the switching indicator, the UE 710 may switch to DL BWP2 and receive the Msg4 in the DL BWP2.

If the UL grant in the Msg2 750 for scheduling the Msg3 does not contain any switching indicator, the UE may receive the Msg4 in the same DL BWP in which the Msg2 750 is received.

The DL BWP used for receiving the Msg4 may be the same as or different from the DL BWP used for receiving the Msg2 750.

For example, the Msg2 750 is received in the DL BWP1 due to that the DL BWP2 is configured but deactivated, if the switching indicator in the Msg2 750 activates the DL BWP2, the Msg4 is received in the DL BWP2.

For example, the Msg2 750 is received in the DL BWP2 due to that the DL BWP2 is configured and activated, if the switching indicator in the Msg2 750 deactivates the DL BWP2, the Msg4 is received in the DL BWPX1.

For example, the Msg2 750 is received in the DL BWP2 due to that the DL BWP2 is configured and activated, if the Msg2 750 does not contain a switching indicator, the UE continues to use the DL BWP2 for reception of the Msg4.

For example, the Msg2 750 is received in the DL BWP1 due to that the UL BWP2 is configured but deactivated, if the Msg2 750 does not contain a switching indicator, the UE continues to use the DL BWP1 for reception of the Msg4.

In some embodiments, if the Msg2 750 does not match the Msg1 740, the RA fails.

In some embodiments, if the Msg 4 does not match the Msg3, the RA fails. For example, if the contention resolution ID in the Msg4 is not the one the UE (e.g, the UE 210, the UE 710) sent in the Msg3, it means that the Msg 4 does not match the Msg3.

In some embodiments, if the RA procedure fails, the UE may restart the RA procedure, i.e., the UE may re-transmit the Msgl, re-receive the Msg2. In some embodiments, if the re-received Msg2 matches the re-transmitted Msgl, the UE may further re-transmit the Msg3, and re-receive the Msg4. In some embodiments, if the re-received Msg2 does not match the re-transmitted Msgl, or if the re-received Msg4 does not match the re-transmitted Msg3, the UE may continue to restart the RA procedure again.

In some embodiments, the UL BWP2 can be configured by a configuration in SIB1, when the UE restarts a RA procedure, the UE may check whether the UL BWP2 is activated or deactivated. If the UL BWP2 is deactivated, the UE transmits messages (e.g., the Msgl, the Msg2) in the UL BWP1. If the UL BWP2 is activated, the UE switches to UL BWP2 and transmits messages in the UL BWP2.

In some embodiments, the DL BWP2 can be configured by a configuration in SIB1, when the UE restarts a RA procedure, the UE may check whether the DL BWP2 is activated or deactivated. If the DL BWP2 is activated, the UE receives messages (e.g., the Msg2, the Msg4) in the DL BWP1. If the DL BWP2 is activated, the UE switches to DL BWP2 and receives messages in the DL BWP2.

In some embodiments, the UE may record the number of consecutive failures of the RA procedure.

In some embodiments, the UE records the number of consecutive failures of the RA procedure. When the UE restart a RA procedure, even if the DL BWP2 or the UL BWP2 is configured and activated, the UE may still use the legacy BWPs if the number of consecutive failures of the RA procedure does not exceed a certain number.

During the restarted RA procedure, if at least one of the DL BWP2 and the UL BWP2 is configured, the UE may check whether the re-received Msg2 contains a corresponding switching indicator in a UL grant for scheduling the Msg3 or in a MAC sub PDU.

In some embodiments, re-transmitting the Msg1 includes: re-transmitting the Msg1 in the UL BWP1 if the UL BWP2 is not configured, or configured butdeactivated; or re-transmitting the Msg1 in the UL BWP1 if the UL BWP2 is configured and activated yet the number of consecutive RA failures is less than or equals to a first value; or re-transmitting the Msg1 in the UL BWP2 if the UL BWP2 is configured and activated and the number of consecutive RA failures exceeds the first value. If the number of consecutive RA failures is less than or equals to the first value, even if the UL BWP2 is activated and configured, the UE may not use the UL BWP2.

In some embodiments, re-transmitting the Msg3 includes: re-transmitting the Msg3 in the UL BWP1 if the UL BWP2 is not configured, or configured but deactivated; or re-transmitting the Msg3 in the UL BWP1 if the UL BWP2 is configured and activated yet the number of consecutive RA failures is less than or equals to a first value; or re-transmitting the Msg3 in the UL BWP2 if the UL BWP2 is configured and activated and the number of consecutive RA failures of the Msg1 exceeds the first value. If the number of consecutive RA failures is less than or equals to the first value, even if the UL BWP2 is activated and configured, the UE may not use the UL BWP2.

In some embodiments, the first value is an integer greater than or equals to zero and set by the UE, or the BS, or preconfigured.

In some embodiments, re-receiving the Msg2 includes: re-receiving the Msg2 in the DL BWP1 if the DL BWP2 is not configured, or configured but deactivated; or re-receiving the Msg2 in the DL BWP1 if the DL BWP2 is configured and activated yet a number of consecutive RA failures is less than or equals to a second value; or re-receiving the Msg2 in the DL BWP2 if the DL BWP2 is configured and activated and the number of consecutive RA failures exceeds the second value. If the number of consecutive RA failures is less than or equals to the second value, even if the DL BWP2 is activated and configured, the UE may not use the DL BWP2.

In some embodiments, re-receiving the Msg4 includes: re-receiving the Msg4 in the DL BWP1 if the DL BWP2 is not configured, or configured but deactivated; or re-receiving the Msg4 in the DL BWP1 if the DL BWP2 is configured and activated yet a number of consecutive RA failures is less than or equals to a second value; or re-receiving the Msg4 in the DL BWP2 if the DL BWP2 is configured and activated and the number of consecutive RA failures exceeds the second value. If the number of consecutive RA failures is less than or equals to the second value, even if the DL BWP2 is activated and configured, the UE may not use the DL BWP2.

In some embodiments, the second value is an integer greater than or equals to zero and set by the UE, or the BS, or preconfigured.

By the usage of the configuration (e.g., the configuration 230, the configuration 730) and/or the switching indicator, the BS may flexibly switch a UE to perform a RA in BWPs other than the legacy BWPs used by the legacy UEs. For example, the BS can switch a UL of a UE from the UL BWP1 to the UL BWP2, and/or switch a DL of a UE from the DL BWP1 to the DL BWP2. The UE may be a RedCap UE or belong to a specific type of the RedCap UEs.

The advantage is to reduce the collision in frequency between the legacy UEs and the RedCap UEs or the collisison in frequency between the legacy UEs and a specific type of the RedCap UEs during the RA procedure, so as to reduce the performance degradation of the legacy UEs during the RA procedure. The advantage is more extraordinary for the case that there are a large number of RedCap UEs in the network.

In some embodiments, the Msg2 may contain a sleep indicator in a MAC sub PDU, the sleep indicator indicates that if the number of consecutive failures of the RA exceeds a third value, the UE may sleep for a sleep duration before restarting the next RA procedure.

In some embodiments, the third value is an integer greater than or equals to zero and set by the UE, or the BS, or preconfigured.

In some embodiments, the sleep duration is configured either in SIB1 or in the Msg2.

In some embodiments, the BS predefines a table which includes a set of candidate time periods. The BS may select at least one candidate from the table as the sleep duration and configures the UE accordingly.

In some embodiments, the UE may randomly select one candidate from the at least one candidate configured by the BS.

In some embodiments, in addition, the UE may further select a random backoff duration according to a uniform distribution between 0 and PREAMBLE_BACKOFF. If the number of consecutive failures of the RA exceeds the second number, the UE may restart the next RA procedure after a sleep duration and a backoff duration.

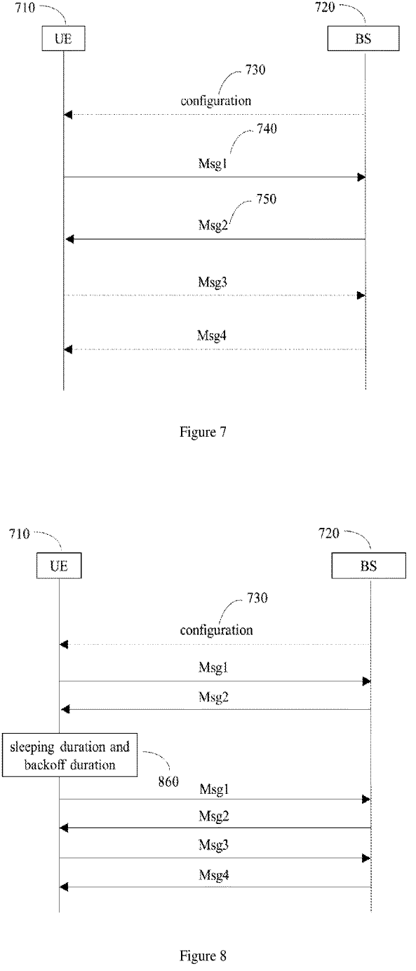

FIG. 8 illustrates an exemplary signal sequence for a restarted RA procedure, wherein the third value is set or pre-configured to be 0.

In this example, the UE performs a RA but fails due to the Msg2 does not contain the preamble transmitted in Msg1.As the second value is 0, the UE may sleep for a sleep duration and back off for a backoff duration (860) before restart the RA procedure.

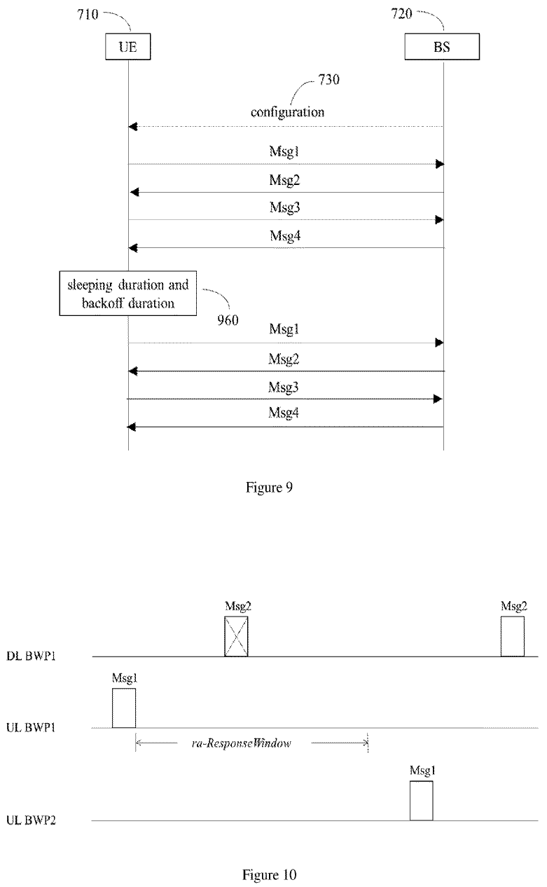

FIG. 9 illustrates an exemplary signal sequence for restart a RA procedure, wherein the second value is set or pre-configured to be 0.

In this example, the UE performs a RA yet fails due to the Msg4 does not contain the contention resolution ID transmitted in Msg3. As the second value is 0, the UE may sleep for a sleep duration and back off for a backoff duration (960) before restart the RA procedure.

In some embodiments, the Msg2 contains a parameter BACKOFF_start, wherein BACKOFF_start is larger than the one for the backoff time of the legacy UEs. If the number of consecutive failures of the RA procedure exceeds a third number, the UE may randomly select a backoff duration according to a uniform distribution between BACKOFF_start and PREAMBLE_BACKOFF and restart the next RA procedure after the backoff duration.

By the usage of the sleep duration and/or the backoff duration, the BS may flexibly scatter the restart time of a UE RA procedure in a broader time duration or in a different time duration. The UE may be a RedCap UE or belong to a specific type of the RedCap UE.

The advantage is to reduce the collision in time between the legacy UEs and the RedCap UEs during the RA procedure, so as to reduce the performance degradation of the legacy UEs during the RA procedure. The advantage is more extraordinary for the case that there are a large number of RedCap UEs in the network.

FIGS. 10-14 illustrate several examples of restart RAs due to RA failures. However, the present disclosure is not limited to these examples.

In the example shown in FIG. 10, the UL BWP1 and the DL BWP1 are available for all the UEs, the UL BWP2 is configured but deactivated by the SIB1, and the DL BWP2 is not configured. The BS does not configure the first value or the first value is set to be 0. Furthermore, the BS does not configure the sleep duration, and the backoff duration is 0.

The UE performs a RA. It transmits the Msg1 in the UL BWP1, and receives the Msg2 in the DL BWP1. As the Msg2 does not match the Msgl, the UE restarts the RA. In this example, a MAC sub PDU of the Msg2 contains a switching indicator activating the UL BWP2. When the UE restart the RA, it re-transmits the Msg1 in the UL BWP2 and receive the Msg2 in the DL BWP1.

In the example shown in FIG. 11, the UL BWP1 and the DL BWP1 are available for all the UEs, the UL BWP2 is configured and activated by the SIB1, and the DL BWP2 is not configured. The BS configures the first value to be 1. Furthermore, the BS does not configure the sleep duration, and the backoff duration is 0.

The UE performs a RA. It transmits the Msg1 in the UL BWP2, and receives the Msg2 in the DL BWP1. The Msg2 matches the Msgl, and the UL grant specific for scheduling the Msg3 does not contain any switching indicator. Then the UE continues to transmit the Msg3 in the UL BWP2 and receive the Msg4 in the DL BWP1. The Msg4 does not match the Msg3, it means the RA fails. The UE restart the RA. The number of consecutive RA failures is 1 and the first value is 1, the UE re-transmits the Msg1 and the Msg3 in the UL BWP1, and re-receives the Msg2 and the Msg4 in the DL BWP1.

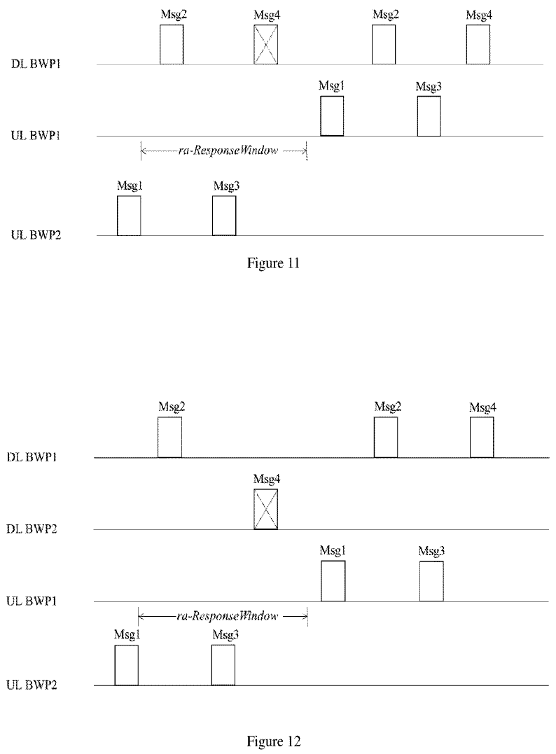

In the example shown in FIG. 12, the UL BWP1 and the DL BWP1 are available for all the UEs, the UL BWP2 is configured and activated by the SIB1, and the DL BWP2 is configured but deactivated by SIB1. The BS configures both the first value and the second value to be 2. Furthermore, the BS does not configure a sleep duration and a backoff duration is 0.

The UE performs a RA. It transmits the Msg1 in the UL BWP2, and receives the Msg2 in the DL BWP1. The Msg2 matches the Msgl, and the UL grant specific for scheduling the Msg3 contain a switching indicator activating the UL BWP2 and the DL BWP2. Then the UE continues to transmit the Msg3 in the UL BWP2 and receive the Msg4 in the DL BWP2. The RA fails due to that the Msg4 does not match the Msg3. The UE restart the RA. The number of consecutive RA failures is 1, the UE re-transmits the Msg1 and the Msg3 in the UL BWP1, and re-receive the Msg2 and the Msg4 in the DL BWP1.

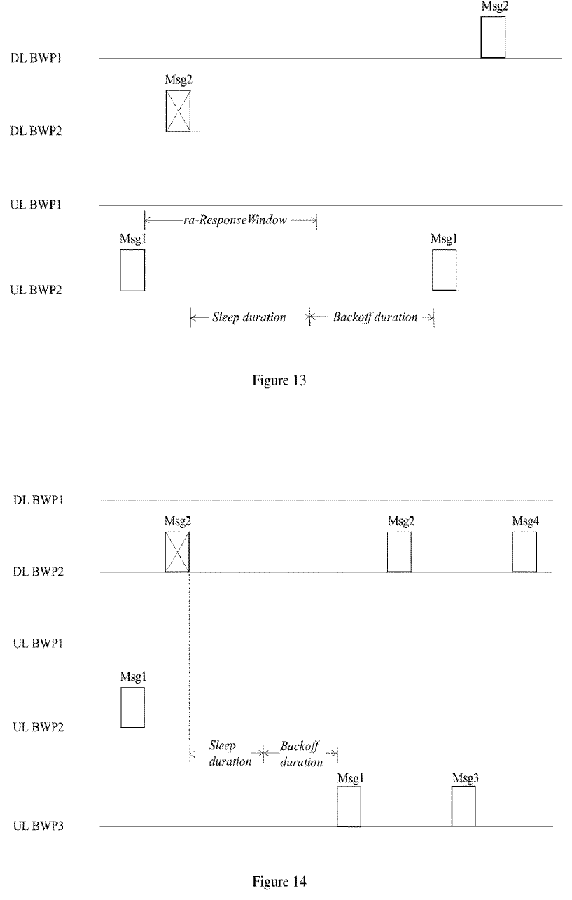

In the example shown in FIG. 13, the UL BWP1 and the DL BWP1 are available for all the UEs, the UL BWP2 and the DL BWP2 are configured and activated by the SIB1. The BS configures all the first value, the second value, and the third value to be 0. Furthermore, the BS configures a non-zero sleep duration and a non-zero backoff duration.

The UE performs a RA procedure. It transmits the Msg1 in the UL BWP2, and receives the Msg2 in the DL BWP2. The RA fails due to that the Msg2 does not match the Msg1.Furthermore, a MAC sub PDU in the Msg2 contains a switching indicator deactivating the DL BWP2 and a sleep indicator indicating the UE sleep for a sleep duration, wherein the sleep duration is configured in a MAC sub PDU. After a sleep duration and a backoff duration, the UE restart the RA procedure. The UE re-transmits the Msg1 in the UL BWP2, and re-receive the Msg2 in the DL BWP1.

In the example shown in FIG. 14, the UL BWP1 and the DL BWP1 are available for all the UEs, the UL BWP2 and the DL BWP2 are configured and activated by the SIB1, and the UL BWP3 is configured but deactivated by the SIB1. The BS configures all the first value, the second value, and the third value to be 0.

The UE performs a RA procedure. It transmits the Msg1 in the UL BWP2, and receives the Msg2 in the DL BWP2. The RA fails due to that the Msg2 does not match the Msg1.Furthermore, a MAC sub PDU in the Msg2 contains a switching indicator deactivating the UL BWP2 and activating the UL BWP3, and contains a sleep indicator indicating the UE sleep for a sleep duration, wherein the sleep duration is configured in a MAC sub PDU. After a sleep duration and a backoff duration, the UE restart the RA. The UE re-transmits the Msg1 in the UL BWP3, and re-receive the Msg2 in the DL BWP2. The re-received Msg2 matches the re-transmitted Msg1 and does not contain any switching indicator. In this example, the UE continues to transmit the Msg3 in the UL BWP3 and receive the Msg4 in the DL BWP2. In this example, the Msg3 matches the Msg4. The restated RA is successful.

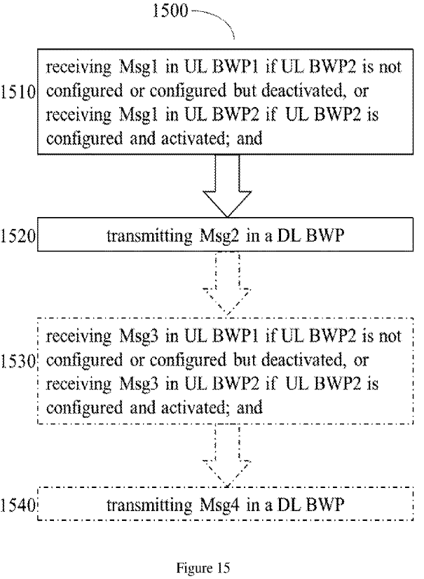

FIG. 15 illustrates an exemplary method 1500 performed by a BS (e.g., the BS 220) to perform a RA according to the present disclosure.

As shown in FIG. 15, the method 1500 may at least include an operation 1510 of receiving an Msg1 in a UL BWP1 if the UL BWP2 is not configured or configured but deactivated, or receiving the Msg1 in the UL BWP2 if the UL BWP2 is configured and activated, and an operation 1520 of transmitting a Msg2 in a DL BWP, wherein the UL BWP1 is a legacy UL BWP which is configured in SIB1 by the BS and is available for all the UEs.

In some embodiments, the BS may further include an operation 1530 of receiving an Msg3 in a UL BWP1 if the UL BWP2 is not configured or configured but deactivated, or receiving the Msg3 in the UL BWP2 if the UL BWP2 is configured and activated, and an operation 1540 of transmitting a Msg4 in a DL BWP.

In some embodiments, the operation 1520 of transmitting a Msg2 further comprising transmitting an Msg2 in a DL BWP1 if the DL BWP2 is not configured or configured but deactivated, or transmitting the Msg2 in the DL BWP2 if the DL BWP2 is configured and activated, wherein the DL BWP1 is a legacy DL BWP which is configured in SIB1 by the BS and is available for all the UEs..

In some embodiments, the operation 1540 of transmitting a Msg4 further comprising transmitting an Msg2 in a DL BWP1 if the DL BWP2 is not configured or configured but deactivated, or transmitting the Msg4 in the DL BWP2 if the DL BWP2 is configured and activated.

In some embodiments, the BS may or may not send a configuration (e.g., the configuration 230, the configuration 730) to the UE. If the BS does not transmit the configuration, the UE may perform a legacy RA by using the UL BWP1 and the DL BWP1.

In some embodiments, the configuration may be contained in the SIB1.

In some embodiments, the configuration configures and activates or deactivates at least one of the UL BWP2 and the DL BWP2.

In some embodiments, the configuration at least configures a DL BWP2, and activates or deactivates the UL BWP2.

In some embodiments, the UL BWP2 is configured by a signaling in the SIB1, and is activated or deactivated by another signaling in the SIB1.

In some embodiments, the DL BWP2 is configured by a signaling in the SIB1, and is activated or deactivated by another signaling in the SIB1.

In some embodiments, the configuration may include a sleep duration.

In some embodiments, the Msg2 may not include a switching indicator.

In some embodiments, the Msg2 may include at least one switching indicator in a MAC sub PDU or in a UL grant for scheduling a Msg3, wherein the switching indicator may activate or deactivate at least one of the DL BWP2 and UL BWP2.

In some embodiments, the Msg2 may include at least one switching indicator in MAC sub PDU and at least one switching indicator in a UL grant for scheduling the Msg3.

In some embodiments, the Msg2 may include a sleep duration.

In some embodiments, the Msg2 may include a sleep indicator in a MAC sub PUD.

According to the various embodiments and various examples mentioned above, the present disclosure may provide additional UL BWP2 and DL BWP2 for the RA. By using the configuration (e.g., the configuration 230, the configuration 730) and/or the switching indicator, and/or the sleep duration and the sleep indicator, the BS may flexibly configure the RA frequency and the RA time. Therefore, the BS may separate a RA from a legacy RA in terms of frequency and/or time resource

In some scenarios, e.g., when there are a large number of RedCap UEs trying to access the network, the RA environment for the legacy UEs (e.g., the eMBB and URLLC UEs) might be degraded. To avoid this problem, the BS may flexibly switch the RedCap UEs or a specific type of the RedCap UEs to other BWPs, and scatter the restart of the RA procedures of these UEs in a broader range if their RA procedures fail. That is to say, the present disclosure may flexibly separate the RedCap UEs or a specific type of the RedCap UEs from the legacy UEs in terms of frequency and time resources, so as to reduce the RA resources collision rate between the RedCap UEs (or a specific type of the RedCap UEs) and the legacy UEs. The influence of the RedCap UEs on the RA of the legacy UEs is decreased.

The various methods, embodiments and examples described above can be reasonably modified and expanded, and can be reasonably combined without contradicting each other, as long as they do not violate the spirit or principle of the present invention.

For example, according to the spirit of the present application, the BS may support at least one UL BWP and at least one DL BWP in addition to the legacy BWPs (e.g., the DL BWP1 and the UL BWP1).

The configuration in the SIB1 may configure and activate or deactivate at least one of the at least one UL BWP and the at least one DL BWP. The switching indicator may activate or deactivate at least one UL BWP and the at least one DL BWP. Referring to the example shown in the FIG. 14, the BS supports a DL BWP2, a UL BWP2, and a UL BWP3, in addition to the legacy BWPs (UL BWP1 and DL BWP1).

In some embodiments, the BS may monitor all the configured and activated UL BWPs in addition to the UL BWP1 for receiving messages.

In some embodiments, the BS may monitor all the configured and activated DL BWPs in addition to the DL BWP1 for transmitting messages.

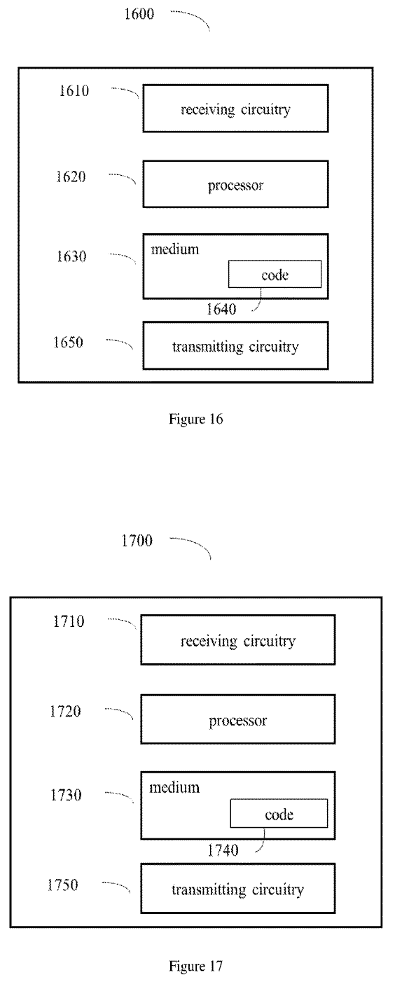

FIG. 16 illustrates an exemplary apparatus 1600 for performing an RA in an embodiment, which, for example, may be at least a part of a UE (e.g. the UE 210 or the UE 710).

As shown in FIG. 16, the apparatus 1600 may include at least one receiving circuitry 1610, at least one processor 1620, at least one non-transitory computer-readable medium 1630 with computer-executable 1640 stored thereon, and at least one transmitting circuitry 1650. The at least one medium 1630 and the computer program code 1640 may be configured to, with the at least one processor 1620, cause the apparatus 1600 to perform at least the example methods (e.g, the methods 100, 400, 600), and the embodiments described above, wherein, for example, the apparatus 1600 may be the UE in the example method 600.

FIG. 17 illustrates an exemplary apparatus 1700 for perform an RA in an embodiment, which, for example, may be at least a part of a BS (e.g. the BS 220 or the BS 720).

As shown in FIG. 17, the apparatus 1700 may include at least one receiving circuitry 1710, at least one processor 1720, at least one non-transitory computer-readable medium 1730 with computer-executable 1740 stored thereon, and at least one transmitting circuitry 1750. The at least one medium 1730 and the computer program code 1740 may be configured to, with the at least one processor 1720, cause the apparatus 1700 to perform at least the example method 1500, and the embodiments described above.

In various example embodiments, the at least one processor 1620 or 1720 may include, but not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the at least one processor 1620 or 1720 may also include at least one other circuitry or element not shown in FIG. 16 or17.

In various example embodiments, the at least one medium 1630 or 1730 may include at least one storage medium in various forms, such as a volatile memory and/or a non-volatile memory. The volatile memory may include, but not limited to, for example, an RAM, a cache, and so on. The non-volatile memory may include, but not limited to, for example, an ROM, a hard disk, a flash memory, and so on. Further, the at least medium 1630 or 1730 may include, but are not limited to, an electric, a magnetic, an optical, an electromagnetic, an infrared, or a semiconductor system, apparatus, or device or any combination of the above.

Further, in various example embodiments, the exemplary apparatus 1600 or 1700 may also include at least one other circuitry, element, and interface, for example antenna element, and the like.

In various example embodiments, the circuitries, parts, elements, and interfaces in the exemplary apparatus 1600 or 1700, including the at least one processor 1620 or 1720 and the at least one medium 1630 or 1730, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A method of a user equipment (UE), comprising:
transmitting a first message type in at least one of:
a first uplink bandwidth part (BWP) if at least a second uplink BWP is not configured;
the first uplink BWP if the at least second uplink BWP is configured but deactivated; or
the at least second uplink BWP if the at least second uplink BWP is configured and activated; and
receiving a first response message type, the first uplink BWP configured in a system information block 1 (SIB1).

2. The method of claim 1, wherein if the first message type matches the first response message type, the method further comprising:
transmitting a second message type in the first uplink BWP if the at least second uplink BWP is not configured or configured but deactivated, or in the at least second uplink BWP if the at least second uplink BWP is configured and activated; and
receiving a second response message type.

3. The method of claim 1, wherein the at least second uplink BWP is configured and one of activated or deactivated by a configuration included in the SIB1.

4. The method of claim 3, wherein the at least second uplink BWP is configured by a first signaling in the SIB1 and the at least second uplink BWP is activated or deactivated by a second signaling in the SIB1.

5. The method of claim 3, wherein the at least second uplink BWP is activated or deactivated by a switching indicator included in the first response message type.

6-10. (canceled)

11. The method of claim 1, wherein receiving the first response message type comprises receiving the first response message type in at least one of:
a first downlink BWP if at least a second downlink BWP is not configured;
the first downlink BWP if the at least second downlink BWP is configured but deactivated; or
the at least second downlink BWP if the at least second downlink BWP is configured and activated.

12. (canceled)

13. The method of claim 11, wherein the at least second downlink BWP is configured and one of activated or deactivated by a configuration included in the SIB1.

14. The method of claim 13, wherein the at least second downlink BWP is activated or deactivated by a switching indicator included in the first response message type.

15-19. (canceled)

20. An apparatus, comprising:
a receiving circuitry;
a transmitting circuitry; and
a processor coupled to the receiving circuitry and the transmitting circuitry configured to cause the apparatus to:
receive a first message type in at least one of:
a first uplink bandwidth part (BWP) if at least a second uplink BWP is not configured;
the first uplink BWP if the at least second uplink BWP is configured but deactivated; or
the at least second uplink BWP if the at least second uplink BWP is configured and activated; and transmit a first response message type, the first uplink BWP configured by the apparatus.

21. The apparatus of claim 20, further comprising: wherein the processor coupled to the receiving circuitry and the transmitting circuitry is configured to cause the apparatus to:
receive a second message type in the first uplink BWP if the at least second uplink BWP is not configured or configured but deactivated, or receive the second message type in the at least second uplink BWP if the at least second uplink BWP is configured and activated; and
transmit a second response message type.

22. The method of claim 20, wherein the at least second uplink BWP is configured and one of activated or deactivated by a configuration included in a system information block 1 (SIB1) transmitted from the apparatus.

23. The method of claim 22, wherein the at least second uplink BWP is activated or deactivated by a switching indicator included in the first response message type.

24-29. (canceled)

30. An apparatus, comprising:
a receiving circuitry;
a transmitting circuitry; and
a processor coupled to the receiving circuitry and the transmitting circuitry configured to cause the apparatus to:
transmit a first message type in at least one of:
a first uplink bandwidth part (BWP) if at least a second uplink BWP is not configured;
the first uplink BWP if the at least second uplink BWP is configured but deactivated; or
the at least second uplink BWP if the at least second uplink BWP is configured and activated; and
receive a first response message type, the first uplink BWP configured in a system information block 1 (SIB1).

31. (canceled)

32. The apparatus of claim 30, wherein if the first message type matches the first response message type, the processor coupled to the receiving circuitry and the transmitting circuitry is configured to cause the apparatus to:
transmit a second message type in the first uplink BWP if the at least second uplink BWP is not configured or configured but deactivated, or in the at least second uplink BWP if the at least second uplink BWP is configured and activated; and
receive a second response message type.

33. The apparatus of claim 30, wherein the at least second uplink BWP is configured and one of activated or deactivated by a configuration included in the SIB1.

34. The apparatus of claim 33, wherein the at least second uplink BWP is configured by a first signaling in the SIB1 and the at least second uplink BWP is activated or deactivated by a second signaling in the SIB1.

35. The apparatus of claim 33, wherein the at least second uplink BWP is activated or deactivated by a switching indicator included in the first response message type.

36. The apparatus of claim 30, wherein the first response message type is received in at least one of:
a first downlink BWP if at least a second downlink BWP is not configured;
the first downlink BWP if the at least second downlink BWP is configured but deactivated; or
the at least second downlink BWP if the at least second downlink BWP is configured and activated.

37. The apparatus of claim 36, wherein the at least second downlink BWP is configured and one of activated or deactivated by a configuration included in the SIB1.

38. The apparatus of claim 37, wherein the at least second downlink BWP is activated or deactivated by a switching indicator included in the first response message type.
